(19) United States
(12) Patent Application Publication
(10) Pub. No.: US 2026/0051606 A1
(43) Pub. Date: Feb. 19, 2026

(54) TRACTION BATTERY PACK THERMAL BARRIER WITH DETACHED VENT PLUGS

(71) Applicant: Ford Global Technologies, LLC, Dearborn, MI (US)

(72) Inventors: Patrick Roxin, Livonia, MI (US); Di Zhu, Novi, MI (US); Bhaskara Rao Boddakayala, Troy, MI (US); Gary J. Haddix, Monroe, MI (US); Joseph Polizzi, Chesterfield, MI (US); Eid Farha, Ypsilanti, MI (US); Shuya Shark Yamada, Novi, MI (US)

(21) Appl. No.: 18/802,608

(22) Filed: Aug. 13, 2024

(51) Int. Cl. H01M 50/308; H01M 10/658; H01M 50/249; H01M 50/276

(52) U.S. Cl. CPC H01M 50/308; H01M 10/658; H01M 50/249; H01M 50/276

(57) ABSTRACT

A traction battery pack assembly includes an enclosure, and a battery array within an interior of the enclosure. The battery array includes a plurality of battery cells. A thermal barrier of the assembly has a sheet and one or more barrier vent opening plugs that are each disposed within an barrier vent opening of the sheet. The one or more barrier vent opening plugs are spaced from the sheet.

### TECHNICAL FIELD

This disclosure relates generally to thermal barriers for a traction battery pack and, more particularly, to thermal barriers having a sheet and vent plugs that are separate from the sheet.

### BACKGROUND

A traction battery pack of an electrified vehicle can include groups of battery cells arranged in one or more cell stacks. The traction battery pack includes a plurality of battery cells and various other battery internal components that support electric vehicle propulsion. During a thermal event, battery cells can vent.

### SUMMARY

In some aspects, the techniques described herein relate to a traction battery pack assembly, including: an enclosure; a battery array within an interior of the enclosure, the battery array including a plurality of battery cells; and a thermal barrier having a sheet and one or more barrier vent opening plugs that are each disposed within an barrier vent opening of the sheet, the one or more barrier vent opening plugs spaced from the sheet.

In some aspects, the techniques described herein relate to an assembly, further including an adhesive layer of the thermal barrier, the sheet and the one or more barrier vent opening plugs bonded to the adhesive layer.

In some aspects, the techniques described herein relate to an assembly, further including a cover of the battery array, wherein the adhesive layer bonds the thermal barrier to the cover.

In some aspects, the techniques described herein relate to an assembly, wherein the cover includes a one or more cover vents configured to communicate vent byproducts from the plurality of battery cells to the thermal barrier.

In some aspects, the techniques described herein relate to an assembly, wherein a cross-sectional area of each of the one or more cover vents is less than a cross-sectional area of the barrier vent opening.

In some aspects, the techniques described herein relate to an assembly, wherein the cover is an aluminum or an aluminum alloy.

In some aspects, the techniques described herein relate to an assembly, wherein the sheet is a mica sheet, and the one or more barrier vent opening plugs are one or more mica barrier vent opening plugs.

In some aspects, the techniques described herein relate to an assembly, wherein the one or more barrier vent opening plugs is each spaced from the sheet about an entire circumferential periphery of the one or more barrier vent opening plugs.

In some aspects, the techniques described herein relate to an assembly, wherein the thermal barrier includes a gap between each of the one or more barrier vent opening plugs and the sheet.

In some aspects, the techniques described herein relate to an assembly, wherein the gap is a 0.2 millimeter gap.

In some aspects, the techniques described herein relate to a traction battery pack assembly, including: an enclosure; a battery array within an interior of the enclosure, the battery array including a plurality of battery cells; and a sheet of a thermal barrier, the sheet having one or more barrier vent openings, one or more barrier vent opening plugs of the thermal barrier, each barrier vent opening plug held within a respective one of the barrier vent openings without contacting the sheet.

In some aspects, the techniques described herein relate to an assembly, wherein the sheet is mica, wherein the one or more barrier vent opening plugs are mica.

In some aspects, the techniques described herein relate to an assembly, wherein the sheet is the same material as the one or more barrier vent opening plugs.

In some aspects, the techniques described herein relate to an assembly, further including an adhesive layer that bonds the sheet and the one or more barrier vent opening plugs to the battery array.

In some aspects, the techniques described herein relate to an assembly, further including a cover of the battery array, the cover disposed between the plurality of battery cells and the thermal barrier.

In some aspects, the techniques described herein relate to an assembly, further including a plurality of cover vents in the cover, each of the cover vents at least partially aligned with one of the barrier vent openings.

In some aspects, the techniques described herein relate to an assembly, wherein a cross-sectional area of each of the cover vents is less than a cross-sectional area of the barrier vent openings.

In some aspects, the techniques described herein relate to an assembly, wherein the cover is an aluminum or an aluminum alloy.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded view of a traction battery pack from the electrified vehicle of FIG. 1 according to an exemplary embodiment of the present disclosure

FIG. 3 illustrates a top view of an array cover from the battery pack of FIG. 2.

FIG. 4 illustrates a top view of a thermal barrier from the battery pack of FIG. 2.

FIG. 5 illustrates a top view of the array cover of FIG. 4 covering the thermal barrier of FIG. 4 cover of FIG. 3 with vent plugs of the thermal barrier removed.

FIG. 6 is a section view at line 6-6 in FIG. 5.

### DETAILED DESCRIPTION

This disclosure details exemplary thermal barrier used within a traction battery pack. In particular, this disclosure describes thermal barriers having a sheet and vent plugs that are detached from the sheet. The thermal barrier can include an adhesive layer that holds the vent plugs and the sheet. The vent plugs are disposed in barrier vent openings. Vent byproducts can displace the vent plugs and move through the barrier vent openings.

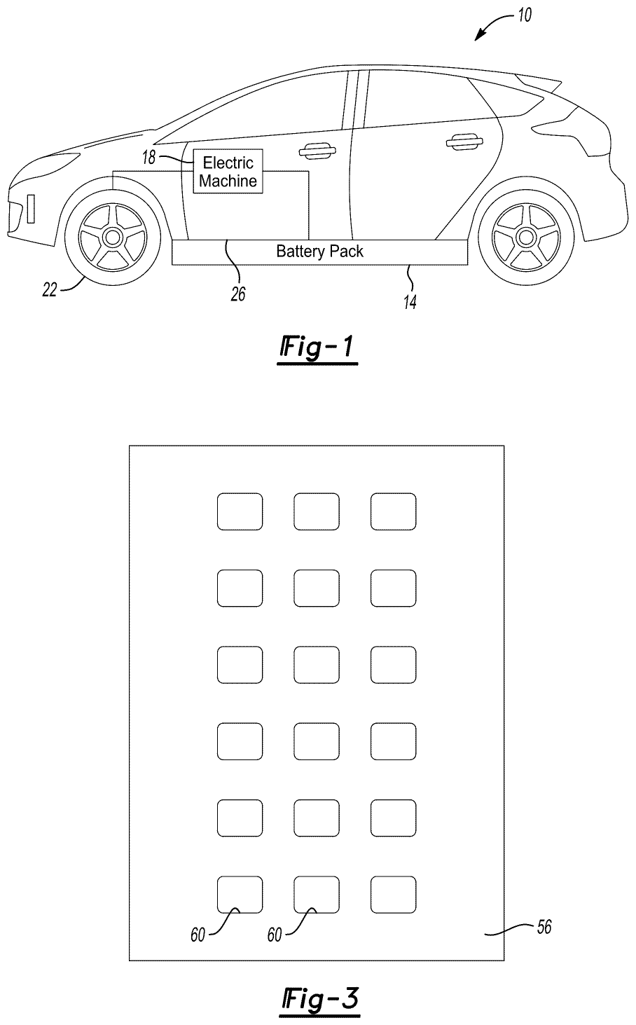

With reference to FIG. 1, an electrified vehicle 10 includes a battery pack 14, an electric machine 18, and wheels 22. The battery pack 14 powers the electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

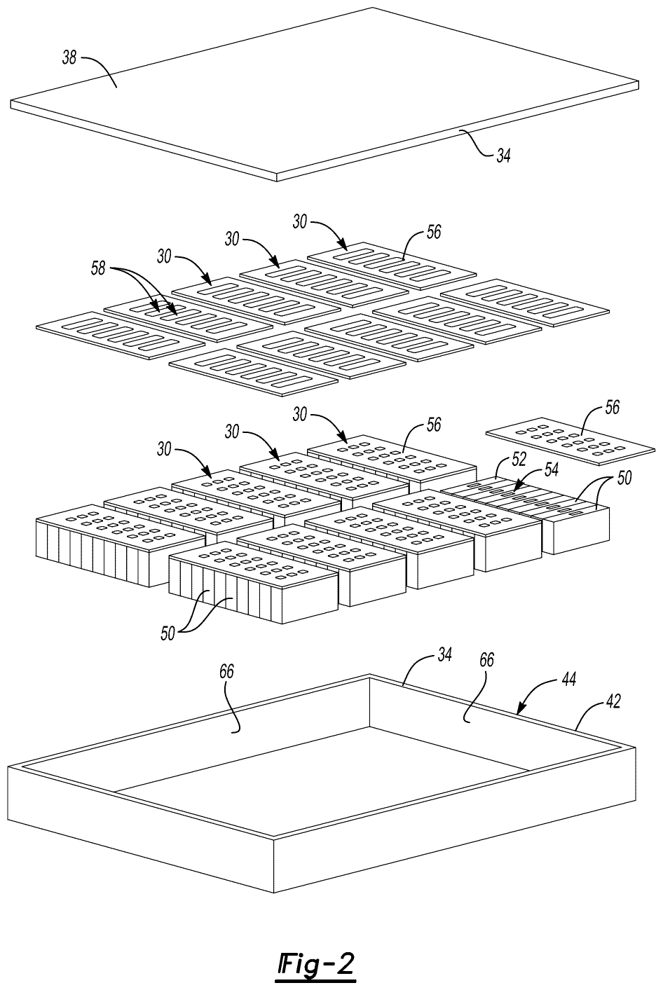

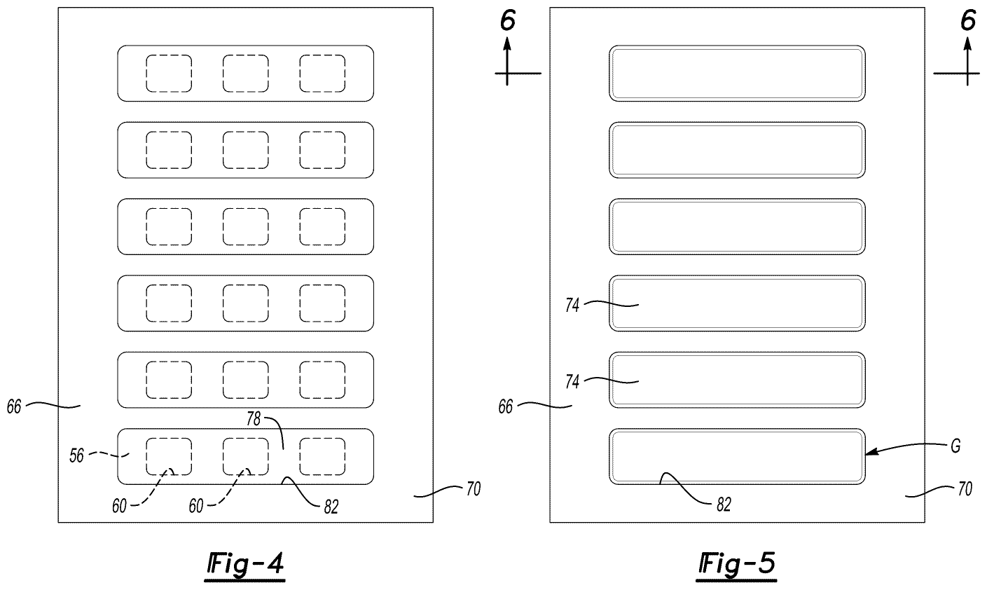

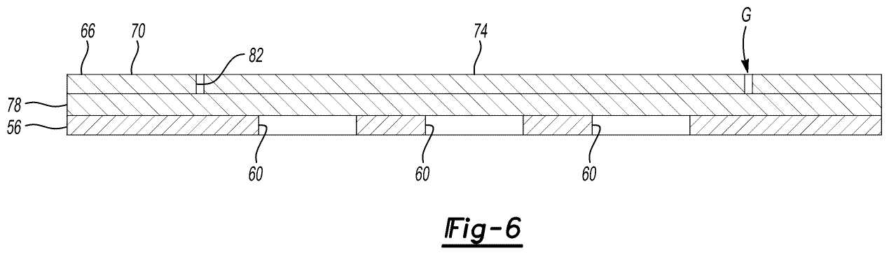

With reference now to FIGS. 2 to 6, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the battery arrays 30. The enclosure cover 38 can be secured to the enclosure tray 42 using mechanical fasteners, for example.

Each of the battery arrays 30 includes a plurality of battery cells 50 (or simply, “cells”) stacked side-by-side relative to each other along a respective cell stack axis A_{A} and sandwiched between endplates 52.

The battery cells 50 store and supply electrical power. Although specific numbers of the battery arrays 30 and cells 50 are illustrated in the various figures of this disclosure, the battery pack 14 could include any number of the battery arrays 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 50 in the battery pack 14 can increase. This can lead to the battery cells 50 expelling vent byproducts, which can include gas and debris.

The vent byproducts can be expelled from the associated battery cell 50 through a designated vent 54 within the housing of the battery cell 50, such as a membrane that yields in response to increased pressure, or through a ruptured area of the associated battery cell 50.

Each of the battery arrays 30, in this example, includes an array cover 56 positioned atop the battery cells 50. The array cover 56 can be an aluminum or aluminum alloy. The array cover 56 includes a plurality of cover vents 60. Within a given array, vent byproducts expelled from one or more of the battery cells 50 can move vertically upward through the cover vents 60 within the array cover 56.

Atop the array cover 56 is a thermal barrier 66 having a sheet 70 and a plurality of vent plugs 74. In this example, the sheet 70 and the vent plugs 74 are bonded to an adhesive layer 78 of the thermal barrier 66, which secures the vent plugs 74 relative to the sheet 70. The sheet 70 includes a plurality of barrier vent openings 82. At least one of the vent plugs 74 is disposed within each of the barrier vent openings 82 during ordinary operation. The vent plugs 74 are detached vent plugs 74 as the vent plugs 74 are not directly attached to the sheet 70. Moving the vent plugs 74 relative to the sheet 70 does not require severing any portion of the sheet 70.

Notably, the vent plugs 74 are positioned within the respective barrier vent openings 82 such that the vent plugs 74 are spaced from the surrounding portions of the sheet 70 and do not contact the sheet 70. A gap G extends circumferentially continuously about an entire periphery of each of the vent plugs 74. In this example, the gap G is 0.2 millimeters. The thermal barrier 66 can be placed atop the array cover 56 such that the barrier vent openings 82 are aligned with one or more of the cover vents 60.

In this example, the barrier vent opening 82 is larger than the cover vents 60. In particular, a cross-sectional area of each of the cover vents 60 is less than a cross-sectional area of the barrier vent openings 82. The cover vents 60 are each nested within one of the barrier vent openings 82. The exemplary embodiment includes three cover vents 60 nested within each barrier vent opening 82. In some examples, the cover vent 60 is concentric with the barrier vent opening 82. In other examples, the cover vent 60 is nonconcentric with the barrier vent opening 82.

The sheet 70 and the vent plugs 74 are the same material in this example. The material can be mica and, more particularly, a rigid mica. In another example, the sheet 70 and the vent plugs 74 could be different materials. A thickness of the sheet 70 and the vent plugs 74 can be 0.5 millimeters.

Vent byproducts that have moved through the cover vents 60 exert, in this example, an vertically upward force against one or more of the vent plugs 74 to sever the adhesive layer 78 in selected areas and displace the vent plug 74 out of the barrier vent opening 82 so that vent byproducts can pass through the barrier vent opening 82. Vertical, for purposes of this disclosure, is with reference to ground and a general orientation of the vehicle 10 during operation.

Vent byproducts that have passed through one of the barrier vent opening 82 are blocked by the sheet 70 and other vent plugs 74 from flowing vertically downward directly adjacent to battery cells 50 that are not venting. Exposing the battery cells 50 that are not venting to these vent byproducts could increase thermal energy levels in the battery cells 50 that are not venting and potentially lead to those battery cells 50 venting.

After passing through the barrier vent opening 82, the vent byproducts remain between the thermal barrier 66 and the enclosure cover 38 until communicated through the enclosure 34 from the interior area 44 of the battery pack 14. An area between the top of the thermal barrier 66 and an underside of the enclosure cover 38 can be greater than 6 millimeters.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure;
a battery array within an interior of the enclosure, the battery array including a plurality of battery cells; and
a thermal barrier having a sheet and one or more barrier vent opening plugs that are each disposed within an barrier vent opening of the sheet, the one or more barrier vent opening plugs spaced from the sheet.

2. The assembly of claim 1, further comprising an adhesive layer of the thermal barrier, the sheet and the one or more barrier vent opening plugs bonded to the adhesive layer.

3. The assembly of claim 2, further comprising a cover of the battery array, wherein the adhesive layer bonds the thermal barrier to the cover.

4. The assembly of claim 3, wherein the cover includes a one or more cover vents configured to communicate vent byproducts from the plurality of battery cells to the thermal barrier.

5. The assembly of claim 4, wherein a cross-sectional area of each of the one or more cover vents is less than a cross-sectional area of the barrier vent opening.

6. The assembly of claim 4, wherein the cover is an aluminum or an aluminum alloy.

7. The assembly of claim 1, wherein the sheet is a mica sheet, and the one or more barrier vent opening plugs are one or more mica barrier vent opening plugs.

8. The assembly of claim 1, wherein the one or more barrier vent opening plugs is each spaced from the sheet about an entire circumferential periphery of the one or more barrier vent opening plugs.

9. The assembly of claim 1, wherein the thermal barrier includes a gap between each of the one or more barrier vent opening plugs and the sheet.

10. The assembly of claim 9, wherein the gap is a 0.2 millimeter gap.

11. A traction battery pack assembly, comprising:
an enclosure;
a battery array within an interior of the enclosure, the battery array including a plurality of battery cells; and
a sheet of a thermal barrier, the sheet having one or more barrier vent openings,
one or more barrier vent opening plugs of the thermal barrier, each barrier vent opening plug held within a respective one of the barrier vent openings without contacting the sheet.

12. The assembly of claim 11, wherein the sheet is mica, wherein the one or more barrier vent opening plugs are mica.

13. The assembly of claim 12, wherein the sheet is the same material as the one or more barrier vent opening plugs.

14. The assembly of claim 11, further comprising an adhesive layer that bonds the sheet and the one or more barrier vent opening plugs to the battery array.

15. The assembly of claim 11, further comprising a cover of the battery array, the cover disposed between the plurality of battery cells and the thermal barrier.

16. The assembly of claim 15, further comprising a plurality of cover vents in the cover, each of the cover vents at least partially aligned with one of the barrier vent openings.

17. The assembly of claim 16, wherein a cross-sectional area of each of the cover vents is less than a cross-sectional area of the barrier vent openings.

18. The assembly of claim 15, wherein the cover is an aluminum or an aluminum alloy.
